(19) United States
(12) Patent Application Publication
(10) Pub. No.: US 2015/0374104 A1
(43) Pub. Date: Dec. 31, 2015

(54) Pocket Bracelet

(71) Applicant: Gabrielle Parker, Washington, DC (US)

(72) Inventor: Gabrielle Parker, Washington, DC (US)

(21) Appl. No.: 14/751,665

(22) Filed: Jun. 26, 2015

Related U.S. Application Data
(60) Provisional application No. 62/017,317, filed on Jun. 26, 2014.

(51) Int. Cl. A45F 3/00; G01S 19/13; A44C 5/00

(52) U.S. Cl. CPC A45F 3/00; A44C 5/003; G01S 19/13; A45F 2003/006

(57) ABSTRACT

The present invention provides a pocket bracelet having an interior pocket. The pocket bracelet is configured to allow users to store personal items therein and decrease the odds of being a target or victim of personal theft. The pocket bracelet includes a body portion having an interior pocket that is accessible through an opening. In a preferred embodiment, the interior pocket is accessible through a first fastener thereon. The interior pocket is adapted to receive personal items therein such as cash and credit cards. The body portion is wrapped and removably fastened around a user's wrist by a second fastener. The pocket bracelet also includes a tracking assembly that allows a user to locate the pocket bracelet in the event that the pocket bracelet is stolen or lost.

### CROSS REFERENCE TO RELATED APPLICATION

This application claims the benefit of U.S. Provisional Application No. 62/017,317 filed on Jun. 26, 2014. The above identified patent application is herein incorporated by reference in its entirety to provide continuity of disclosure.

### BACKGROUND OF THE INVENTION

### Field of the Invention

The present invention relates to personal accessories. More specifically, the present invention pertains to an improved bracelet having a concealed interior pocket that allows for a user to place personal items such as cash, credit cards, and lipstick therein.

One of the most reported crimes are those involved with theft of a purse. Purses are typically bags that can have varying shapes and forms that allow people to make a fashion statement along with storing their personal items. However, as purses have evolved into a fashionable item, they have been recognized as a common target for theft. Purses have become an easy target as they are generally out in the open. Especially taken in conjunction with the fact that purses generally store cash and other valuables, in addition to the monetary value of the purse itself, purses have become particularly attractive targets. There are certain guidelines that people follow to attempt to stave off and prevent purse snatching and other personal thefts.

One of the most repeated protocols to avoiding these personal thefts assert that a person should elude appealing to a thief and therefore, avoid being a possible target. To reduce these odds of being targeted, people advise not carrying a purse, dressing down, and not flaunting jewelry or designer labels that may be indicative of a person's wealth. However, these protocols are generally disagreeable, as purses have become such a fashion statement in addition to the convenience of storing personal items therein that people often ignore these types of prevention strategies. Therefore, there exists a need for a device that allows a person to store personal items that is fashionable and secretive thereby decreasing the odds of being a target or victim of personal theft.

The present invention provides a bracelet having an interior pocket in which a user can store personal items. The bracelet includes a body portion that is preferably rectangular in shape that forms an interior pocket therein. The interior pocket is accessible through an opening. In other preferred embodiments, the interior pocket is accessible through a fastener that is preferably a zip fastener. The ends of the bracelet include a second fastener such as a button fastener or a hook and loop fastener that allows the user to wrap the body portion around his or her wrist. The bracelet further includes a tracking assembly that allows a user to track the location of the bracelet in the event that the bracelet is lost or stolen.

### SUMMARY OF THE INVENTION

In view of the foregoing disadvantages inherent in the known types of bracelets now present in the prior art, the present invention provides a new and improved bracelet having an interior pocket wherein the same can be utilized for storing personal items and preventing users from becoming targets or victims of personal theft.

It is therefore an object of the invention to provide a new and improved pocket bracelet that has all of the advantages of the prior art and none of the disadvantages.

Another object of the present invention is to provide a new and improved pocket bracelet that allows a user to store personal items such as cash and credit cards therein.

Yet another object of the present invention is to provide a new and improved pocket bracelet that allows a user to decrease the odds of becoming a target or victim of personal theft.

Still yet another object of the present invention is to provide a new and improved pocket bracelet that comprises a body portion having an interior pocket therein that is configured to be wrapped and fastened around a user's wrist.

A further object of the present invention is to provide a new and improved pocket bracelet that further includes a tracking assembly that allows a user to track the location of the pocket bracelet in the event that the pocket bracelet is lost or stolen.

Still yet another object of the present invention is to provide a new and improved pocket bracelet wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the present invention.

FIG. 2 shows a side perspective of an alternative preferred embodiment of the present invention.

FIG. 3 shows a schematic diagram of the tracking assembly within the present invention.

### DETAILED DESCRIPTION OF THE INVENTION

References are made herein to the attached drawings. Like reference numerals are used throughout the drawings to depict like or similar elements of the pocket bracelet. For the purposes of presenting a brief and clear description of the present invention, the preferred embodiment will be discussed as used for discretely storing valuables on the user's wrist in order to prevent the user from becoming a victim of theft. The figures are intended for representative purposes only and should not be considered to be limiting in any respect.

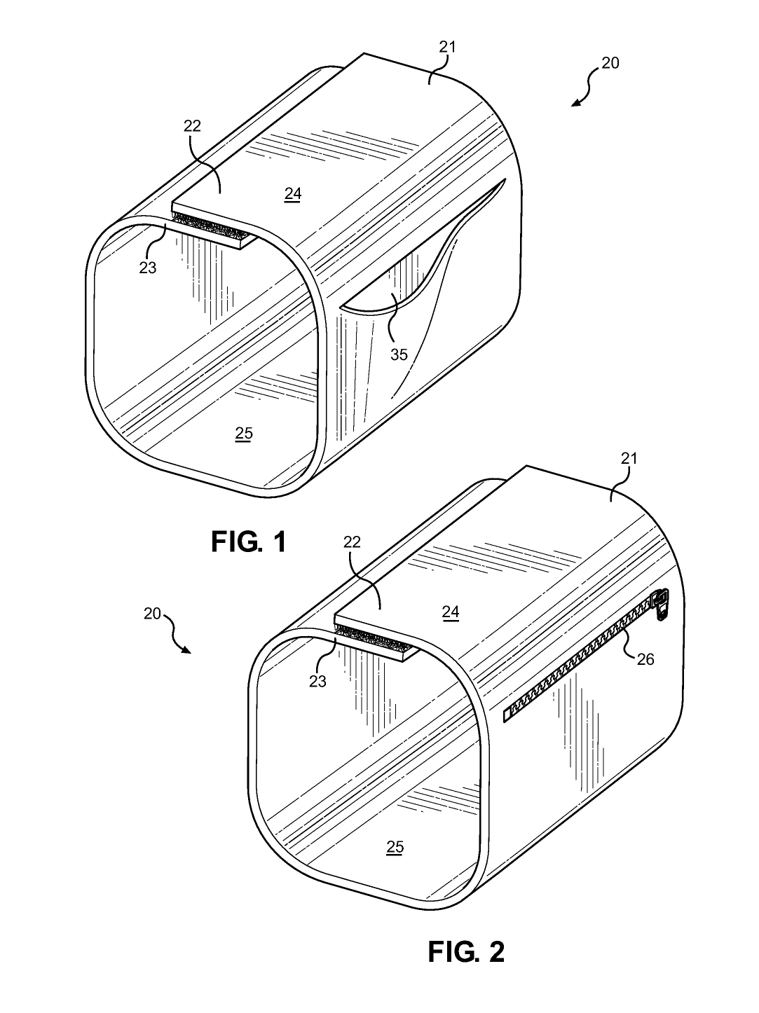

Referring now to FIGS. 1 and 2, there are shown a pair of side perspective views of a pair of preferred embodiments of the pocket bracelet 20. The pocket bracelet 20 is configured to be wrapped and removably fastened around a user's wrist. The pocket bracelet comprises a body portion 21 that is configured to be worn around a carrier's wrist or forearm. The body portion 21 preferably comprises an elongated rectangular shape, however, it is contemplated that other sizes and shapes are suitable in alternative embodiments. The body portion 21 contains a first end 22, a second end 23, an outer surface 24, and an inner surface 25. The upper surface 24 comprises an interior pocket that forms an opening 35 that allows access to the interior pocket disposed on the body portion 21 of the bracelet 20.

In other preferred embodiments, like the one illustrated in FIG. 2, a first fastener 26 is configured to operably seal and provide access to the interior pocket through the opening 35. The interior pocket is configured to receive cash, credit cards, lip stick, and other small items. In this way, the pocket bracelet 20 is particularly advantageous as it provides a secret pocket that can store personal items, so as to eliminate the need for a user to carry a larger sized purse or bag. The pocket bracelet 20 is particularly advantageous over a larger sized purse as it does not draw attention to the user, which cause the user to become recognized as a possible target of theft. In the event that the pocket bracelet 20 is lost or stolen, the pocket bracelet 20 further comprises a tracking assembly that allows a user to track down the pocket bracelet 20.

Preferably, the first fastener 26 is a zip fastener, however, as readily recognized by one of ordinary skill within the art with the present disclosure before them, it is contemplated that other types of fasteners that provide access to the interior pocket are suitable. Specifically, alternative embodiments are composed of string fasteners and button fasteners to provide access to the interior pocket. In addition, the opening 35 and the first fastener 26 are also preferably centrally located on the outer surface 24 of the body portion 21, however it is also contemplated that other locations providing access to the interior pocket are also appropriate.

The first end 22 and the second end 23 further include a second fastener 27 that is configured to removably fasten the first end 22 to the second end 23 in an overlapping configuration in order to allow a user to wear the pocket bracelet 20 around his wrist. As illustrated, the second fastener 27 is a hook and loop fastener, however, other alternative preferred embodiments may be removably fastened with other suitable fasteners, but not limited to button fasteners, string fasteners, and an adjustable strap. Furthermore, the body portion 21 is preferably composed of a thermoplastic or thermoset material, however it is contemplated that other alternative preferred embodiments may be composed of other suitable material such as fabric or leather.

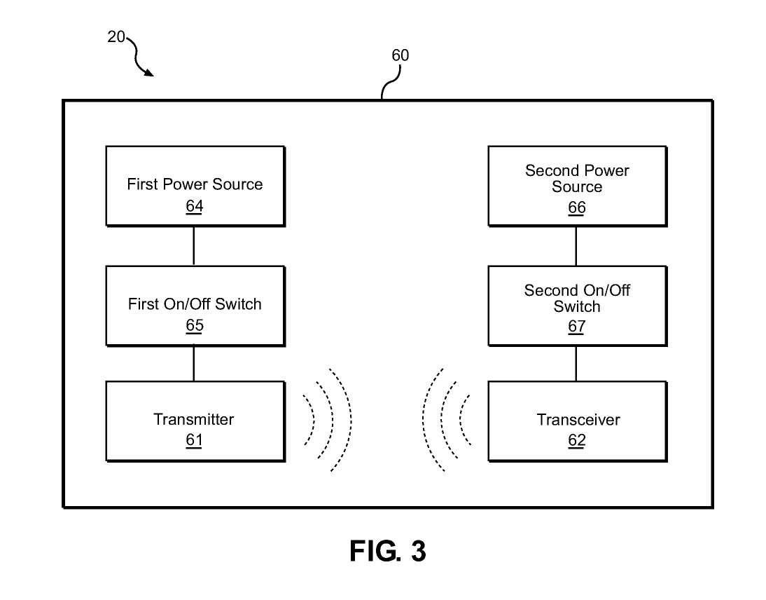

Referring now to FIG. 3, there is shown a schematic diagram of a tracking assembly 60 that is embedded within the body portion of the pocket bracelet 20. The tracking assembly 60 is configured to track and monitor the location of the pocket bracelet 20. The tracking assembly 60 includes a global positioning system (GPS) transmitter 61 embedded within the body portion of the pocket bracelet, which sends a wireless tracking signal to an appropriate GPS transceiver 62 that can be stored in a safe location by the user and retrieved when the pocket bracelet 20 is missing. The GPS transceiver 62 may be a computer, laptop, smartphone, or other similar device such that a user can monitor the location of the bracelet from his or her mobile electronic device. The GPS transmitter 61 is electrically coupled to a first on/off switch 65 and a first power source 64, while the GPS transceiver 62 is electrically coupled to a second on/off switch 67 and a second power source 66.

The GPS transmitter 61 is prompted to send a wireless tracking signal to the GPS transceiver 62 upon receipt of a wireless signal from the GPS transceiver 62. The transceiver 62 may include a display for indicating the location of the bracelet. In this way, the user can track and retrieve a pocket bracelet 20 that was lost. Preferably the on/off switches 65, 67 are rocker switches, however, other embodiments may use other subtle on/off switches that will not draw attention to the switches, especially, in the first on/off switch 65 electrically coupled to the GPS transmitter 61. This is particularly beneficial as a potential thief may not recognize that the pocket bracelet 20 includes a tracking assembly 60. In addition, the first power source 64 is preferably a battery, such as a button cell or a coin cell, which allows the pocket bracelet 20 to stay as compact as possible. The second power source 66 electrically coupled to the GPS transceiver 62 is also preferably a battery, such as an alkaline battery or rechargeable battery.

The GPS transceiver 62 includes GPS mapping capabilities that allows a user to track down the GPS transmitter 61 embedded within the body portion of the pocket bracelet 20. The GPS mapping capabilities include the use a plurality of GPS tracking units together with signals from existing GPS satellites to assist the user in orienting the user's present location relative to the pocket bracelet equipped with the GPS transmitter 61. In this way, the tracking assembly 60 is particularly advantageous as it allows the user to track the location of the pocket bracelet 20 in the event that it is stolen or lost.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pocket bracelet, comprising:
a body portion having a first end, a second end, an outer surface and an inner surface;
said body portion configured to wrap and removably fasten around a user's wrist by overlapping and securing said first end to said second end via a fastener;
an interior pocket disposed within said body portion configured to receive small personal items;
said outer surface comprises an opening configured to provide access to said interior pocket;
a tracking assembly embedded within said body portion.

2) The pocket bracelet of claim 1, wherein said opening is centrally located on said outer surface.

3) The pocket bracelet of claim 1, wherein a fastener is configured to operably seal said opening and provide access to said interior pocket.

4) The pocket bracelet of claim 3, wherein said fastener is configured to operably seal said opening and provide access to said interior pocket includes a zip fastener.

5) The pocket bracelet of claim 1, wherein said fastener configured to removably fasten said body portion around said user's wrist includes hook and loop fasteners.

6) The pocket bracelet of claim 1, wherein:
said tracking assembly includes a GPS transmitter electrically coupled to a first on/off switch and a first power source,

7) The pocket bracelet of claim 6, wherein said GPS transmitter is adapted to transmit the location of said body portion.

8) The pocket bracelet of claim 7, wherein:
said GPS transmitter is adapted to send a wireless tracking signal to said GPS transceiver upon receiving a wireless signal from said GPS transceiver;
wherein said GPS transceiver includes GPS mapping capabilities to allow the user to track said GPS transmitter.

9) The pocket bracelet of claim 6, wherein each said first on/off switch and said second on/off switch includes a rocker switch.

10) The pocket bracelet of claim 6, wherein each said first power source and said second power source includes a battery.
